(19) United States
(12) Patent Application Publication
(10) Pub. No.: US 2015/0156560 A1
(43) Pub. Date: Jun. 4, 2015

(54) APPARATUS FOR TRANSMITTING AUGMENTED BROADCAST METADATA, USER TERMINAL, METHOD FOR TRANSMITTING AUGMENTED BROADCAST METADATA, AND REPRODUCING AUGMENTED BROADCAST METADATA

(71) Applicant: ELECTRONICS AND TELECOMMUNICATIONS RESEARCH INSTITUTE, Daejeon (KR)

(72) Inventors: Bum Suk Choi, Daejeon (KR); Soon Choul Kim, Daejeon (KR); Seung Chul Kim, Daejeon (KR); Jung Hak Kim, Daejeon (KR); Jeoung Lak Ha, Daejeon (KR); Young Ho Jeong, Daejeon (KR); Jin Woo Hong, Daejeon (KR)

(73) Assignee: ELECTRONICS AND TELECOMMUNICATIONS RESEARCH INSTITUTE, Daejeon (KR)

(21) Appl. No.: 14/418,795

(22) PCT Filed: Aug. 9, 2013
(86) PCT No.: PCT/KR2013/007186

§ 371 Date: Jan. 30, 2015

(30) Foreign Application Priority Data
Aug. 9, 2012 (KR) 10-2012-0087316

(51) Int. Cl. H04N 21/81; H04N 5/445; H04N 21/84; H04N 21/236; H04N 21/435; H04N 21/235; H04H 60/73; H04N 21/2389

(52) U.S. Cl. CPC H04N 21/8133; H04H 60/73; H04N 5/44508; H04N 21/23892; H04N 21/23614; H04N 21/435; H04N 21/2353; H04N 21/84

(57) ABSTRACT

An augmented broadcasting metadata (ABM) transmission apparatus is provided, which includes a metadata generation unit to generate ABM which is necessary for augmented content to be overlapped with broadcasting content; and a metadata transmission unit to transmit the ABM to a user terminal.

### TECHNICAL FIELD

The present invention relates to a technology based on an augmented reality (AR) service, the technology of combining a virtual object or information with a real environment, so that the virtual object seems as if being originally in the actual environment.

The present invention relates to an augmented broadcasting metadata (ABM) transmission apparatus and a user terminal receiving the ABM, and more particularly, to a configuration of the ABM related to augmented content, a configuration of a server that transmits ABM to the user terminal using the configuration of the ABM, and a configuration of the user terminal that analyzes and displays the received ABM.

Here, the augmented broadcasting refers to a broadcasting service for increasing reality and movement feeling for a user by naturally combining the augmented content with broadcasting content and enabling selective service reception, breaking away from a conventional method of watching broadcasting content provided by a broadcasting station in a unilateral manner.

### BACKGROUND ART

In relation to a conventional augmented reality (AR) service, Korean Patent Laid-open No. 2011-0088774 introduces an AR providing system and method which provide ambient information data in a direction in which a user of a terminal is looking in a current position, based on the current position of the user and the looking direction.

In detail, in an AR providing server, when the system, which manages information data to be provided to the user in units of area through a database (DB), receives current position information and direction information of an AR providing terminal from the AR providing terminal, the system searches for information data of a direction of the terminal within an area in which the terminal is currently located in the DB based on the received position information and direction information. Next, the system transmits the found information data to the AR providing terminal, and the AR providing terminal combines the information data received from the AR providing server in connection with the AR providing terminal with a real time image obtained by a camera, and displays the combined image.

### DISCLOSURE OF INVENTION

Technical Goals

An aspect of the present invention provides an augmented broadcasting metadata (ABM) transmission apparatus that provides an augmented broadcasting service to a user terminal by transmitting structuralized ABM to the user terminal

Another aspect of the present invention provides an ABM transmission apparatus that provides augmented broadcasting with a relatively small quantity of data by generating next instruction unit data from only changed content of previous instruction unit data.

Yet another aspect of the present invention provides a user terminal that analyzes ABM received from an ABM transmission apparatus and reproduces augmented content along with broadcasting content.

Still another aspect of the present invention provides a user terminal that separates broadcasting content transmitted by one broadcasting stream from ABM and analyzes the separated ABM.

### Technical Solutions

According to an aspect of the present invention, there is provided an augmented broadcasting metadata (ABM) transmission apparatus including a metadata generation unit to generate ABM related to an augmented content to be overlapped with broadcasting content; and a metadata transmission unit to transmit the ABM to a user terminal.

According to another aspect of the present invention, there is provided a user terminal including a metadata receiving unit to receive ABM from an ABM transmission apparatus; a metadata analysis unit to analyze instruction unit data in the ABM; and an augmented content reproduction unit to synchronize the broadcasting content with the augmented content based on the analyzed instruction unit data and reproduce the broadcasting content and the augmented content.

### Effects of Invention

According to embodiments of the present invention, an augmented broadcasting service may be provided to a user terminal by transmitting structuralized augmented broadcasting metadata (ABM) to the user terminal.

According to embodiments of the present invention, a user may be provided with affluent information related to broadcasting content through a combination of an augmented reality (AR) technology and a broadcasting technology. Also, information desired by the user may be provided to the user.

According to embodiments of the present invention, since only changed content of previous instruction unit data is generated as next instruction unit data, augmented broadcasting may be provided with a relatively small quantity of data.

According to embodiments of the present invention, augmented content may be synchronized with broadcasting content and reproduced, by analyzing ABM received from an ABM transmission apparatus.

According to embodiments of the present invention, broadcasting content transmitted with one broadcasting stream and ABM may be separated and the separated ABM may be analyzed.

### BRIEF DESCRIPTION OF DRAWINGS

FIG. 1 is a diagram illustrating an overall configuration of an augmented broadcasting providing system according to an embodiment of the present invention.

FIG. 2 is a diagram illustrating a detailed configuration of an augmented broadcasting metadata (ABM) transmission apparatus and a user terminal, according to an embodiment of the present invention.

FIG. 3 is a diagram illustrating a configuration of instruction unit data according to an embodiment of the present invention.

FIG. 4 is a diagram illustrating an example that augmented content is displayed according to instruction unit data analyzed by a user terminal, according to an embodiment of the present invention.

FIG. 5 is a diagram illustrating an example that an ABM transmission apparatus transmits ABM to a user terminal, according to an embodiment of the present invention.

FIG. 6 is a diagram illustrating an example that augmented content is displayed according to a series of ABM received by a user terminal, according to an embodiment of the present invention.

FIG. 7 is a flowchart illustrating an operation of an ABM transmission apparatus transmitting ABM to a user terminal, according to an embodiment of the present invention.

FIG. 8 is a flowchart illustrating an operation of a user terminal reproducing augmented content, according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

An augmented broadcasting metadata (ABM) transmission method according to the embodiments may be performed by an ABM transmission apparatus. An ABM reproducing method according to the embodiments may be performed by a user terminal.

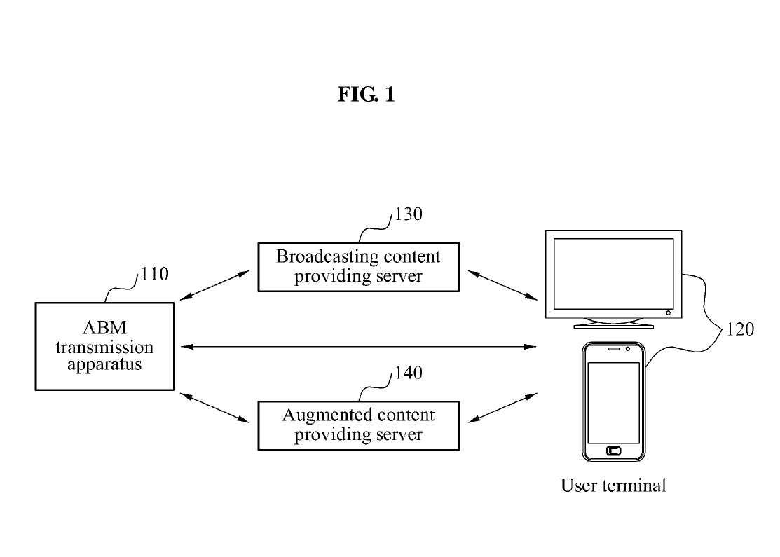

FIG. 1 is a diagram illustrating an overall configuration of an augmented broadcasting providing system according to an embodiment of the present invention.

Referring to FIG. 1, a system for providing augmented broadcasting to a user terminal 120 may include an ABM transmission apparatus 110, a broadcasting content providing server 130, an augmented content providing server 140, and a user terminal 120.

ABM refers to extensible markup language (XML) based metadata which includes information necessary for overlapping augmented content on broadcasting content and displaying the overlapped content. For example, the ABM may refer to XML-based metadata which includes a region or position to express the augmented content, an expression method, a type of the augmented content, attributes of the augmented content, information on various sensors and cameras used for producing broadcasting content, time information for synchronization of the broadcasting content and the augmented content, and the like. The ABM is generated by authoring of a user based on the broadcasting content in an authoring server. A transmission server multiplexes the broadcasting content and the ABM and transmits the broadcasting content and the ABM to a broadcasting terminal. The broadcasting terminal may extracts the ABM from a broadcasting stream, analyzes the ABM, and expresses the augmented content overlappingly on the broadcasting content by synchronizing the ABM with the broadcasting content.

The broadcasting content providing server 130 may provide the broadcasting content to the user terminal 120 or the ABM transmission apparatus 110. The augmented content providing server 140 may provide the augmented content in the form of a virtual object or information to the user terminal 120 or the ABM transmission apparatus 110.

Here, the broadcasting content providing server 130 or the augmented content providing server 140 may be included in the ABM transmission apparatus 110 or provided at an outside of the ABM transmission apparatus 110.

Therefore, depending on cases, the ABM transmission apparatus 110 may transmit the ABM together with the augmented content or the broadcasting content or transmit only the ABM.

When the ABM and the broadcasting content are transmitted together, the ABM transmission apparatus 110 may multiplexes the ABM and the broadcasting content, thereby transmitting the ABM and the broadcasting content by one broadcasting stream. However, the ABM transmission apparatus 110 may transmit the ABM through not only a broadcasting channel but also a hybrid broadcasting channel capable of both broadcasting transmission and data transmission, or a dedicated network such as the Internet.

The ABM transmission apparatus 110 may generate the ABM. The ABM may refer to metadata which designates a particular region of the broadcasting content as an augmented region to express the augmented content, and includes setting data for displaying the augmented content and data related to an augmented content expression method on the augmented region. In addition, the ABM transmission apparatus 110 may transmit the ABM generated as described above to the user terminal 120. Thus, the ABM transmission apparatus 110 may provide the augmented broadcasting service to the user terminal 120.

The user terminal 120 may receive the ABM form the ABM transmission apparatus 110 and analyze the ABM. The user terminal 120 may display the augmented content overlappingly on the broadcasting content, based on the analyzed ABM. The user terminal 120 may include an internet protocol television (IPTV), a smart TV, a hybrid TV, an internet TV, a connected TV, a cable TV (CATV), a smart phone, a smart pad, and the like, capable of data communication.

When the user terminal 120 receives the ABM and the broadcasting content through one broadcasting stream, the user terminal 120 may separate the broadcasting content and the ABM from the broadcasting stream and, while reproducing the broadcasting content through a decoder, may analyze the separated ABM and displaying the augmented content together with the broadcasting content.

The augmented content may be included in the ABM and transmitted to the user terminal 120 along with the ABM, or may be transmitted separately from the augmented content providing server 140. When the user terminal 120 receives the augmented content from the augmented content providing server 140, the user terminal 120 may connect to the augmented content providing server 140 using uniform resource locator (URL) data included in the ABM.

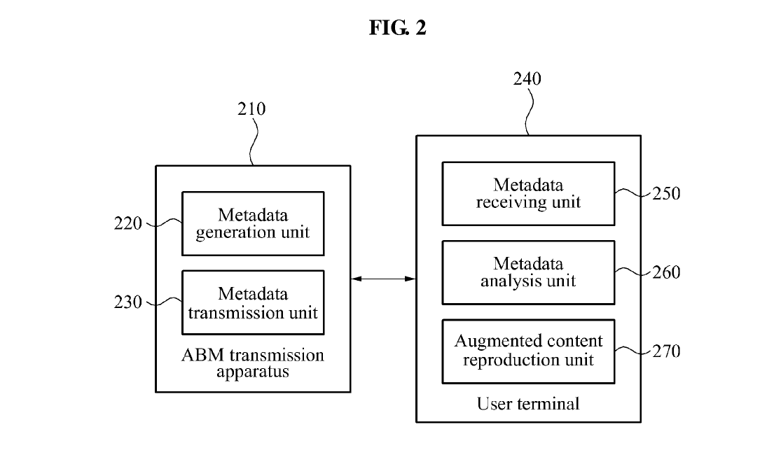

FIG. 2 is a diagram illustrating a detailed configuration of an ABM transmission apparatus 210 and a user terminal 240, according to an embodiment of the present invention.

Referring to FIG. 2, the ABM transmission apparatus 210 may include a metadata generation unit 220 and a metadata transmission unit 230.

The metadata generation unit 220 may generate ABM related to the augmented content to be overlapped with the broadcasting content. Here, the metadata generation unit 220 may generate the ABM in the form of instruction unit data formed by dividing the ABM by time units.

The ABM transmission apparatus 210 may provide the ABM to user terminal 240 through the instruction unit data with reference to the time unit. Thus, the user terminal 240 may synchronize the broadcasting content with the augmented content based on time and display the synchronized content. That is, the user terminal 240 may analyze the augmented content having same time data on the broadcasting content and display the analyzed augmented content along with the broadcasting content.

The metadata generation unit 220 may generate next instruction unit data with respect to only changed data in key instruction unit data including all necessary data in relation to a new augmented region. According to another embodiment, the providing server generation unit 220 may generate the next instruction unit data from only changed data of previous instruction unit data. As a result, the ABM transmission apparatus 210 may provide the augmented broadcasting with a relatively small quantity of data.

The metadata transmission unit 230 may transmit the generated ABM to the user terminal 240.

When the ABM transmission apparatus 210 transmits the broadcasting content and the ABM together, the metadata transmission unit 230 may multiplex the broadcasting content and the ABM and transmit the broadcasting content and the ABM by one broadcasting stream. Additionally, the metadata transmission unit 230 may also transmit the augmented content to the user terminal 240.

Referring to FIG. 2, the user terminal 240 may include a metadata receiving unit 250, a metadata analysis unit 260, and an augmented content reproduction unit 270.

The metadata receiving unit 250 may receive the ABM from the ABM transmission apparatus 210. In addition, depending on cases, the metadata receiving unit 250 may receive the broadcasting content from a broadcasting content providing server or receive the augmented content from an augmented content providing server.

The metadata analysis unit 260 may analyze the instruction unit data in the received ABM. The metadata analysis unit 260 may analyze the instruction unit data based on the time unit, thereby analyzing a display method for the augmented region and the augmented content. That is, the metadata analysis unit 260 may classify the instruction unit data based on the time unit and analyze data included in the instruction unit data, thereby transmitting an augmented content reproduction method and data related to reproduction setting to the augmented content reproduction unit 270.

When the ABM is transmitted with the broadcasting through one broadcasting stream, the metadata analysis unit 260 may analyze the ABM by separating the ABM and the broadcasting content from the broadcasting stream. That is, the metadata analysis unit 260 may separate the broadcasting content and the ABM from the broadcasting stream, and analyze the ABM with respect to a region and time for expressing the augmented content through parsing.

The augmented content reproduction unit 270 may synchronize the augmented content on the broadcasting content based on the analyzed instruction unit data and reproduce the augmented content. The augmented content reproduction unit 270 may reproduce the broadcasting content through a conventional decoder, and reproduce the augmented content overlappingly on the broadcasting content according to setting data of the augmented content included in the ABM, based on the region and time for expressing the augmented content.

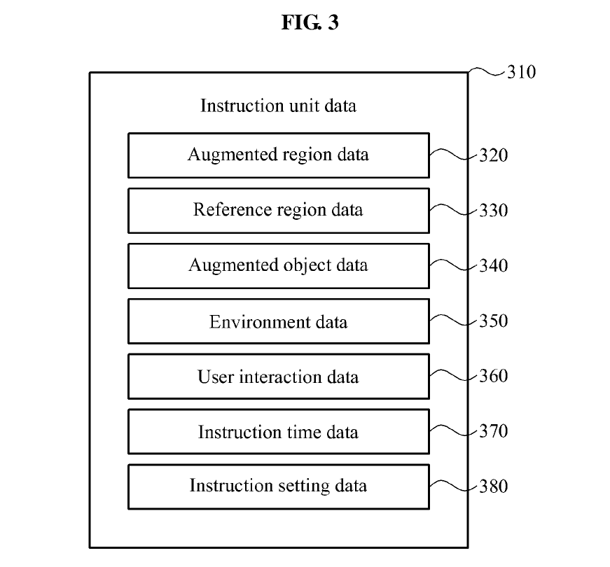

FIG. 3 is a diagram illustrating a configuration of instruction unit data 310 according to an embodiment of the present invention.

The instruction unit data 310 may refer to a data transmission unit formed by dividing ABM to be transmitted to a user terminal based on a time unit by an ABM transmission apparatus.

Referring to FIG. 3, the instruction unit data 310 may include at least one selected from augmented region data 320 which is data related to an augmented region in which the augmented content is to be displayed in an overlapping manner, reference region data 330 related to a position of the augmented region, augmented object data 340 related to attributes of the augmented content, environment data 350 necessary for overlap between the broadcasting content and the augmented content, user interaction data 360 related to the augmented content, and instruction time data 370 necessary for synchronization between the broadcasting content and the augmented content, and instruction setting data 380 for setting of the instruction unit data 310.

The augmented region data 320 may include at least one of augmented region shape data, mask image data which is binary image data for expressing the augmented region, and global positioning system (GPS) data of the augmented region. The GPS data of the augmented region may be used for expressing necessary augmented region according to the GPS data.

The reference region data 330 may include at least one of coordinate data of the augmented region and displacement data of the augmented region. In addition, the reference region data 330 may include boundary data representing a boundary of the mask image included in the augmented region. The reference region data 330 may store data as 3-dimensional (3D) coordinate values which include coordinate values with respect to an x-axis, y-axis, and z-axis, scale values with respect to the axes, rotation values with respect to the axes, and translation values with respect to the axes.

The augmented object data 340 may include at least one of augmented content data embedded in the ABM, URL data related to location of the augmented content when the augmented content is located at the outside of the ABM transmission apparatus, service type data of the augmented object, emotion data of the augmented object, and clear data related to deletion of a previous augmented object.

The service type data of the augmented object defines a service type of the augmented object, for example, entertainment, education, characters, and the like. The emotion data of the augmented object defines emotions of the augmented object such as happiness, sadness, anger, and the like. The clear data may define whether to clear a previous augmented object before overlap of the augmented object. For example, when a value of the augmented object clear data is 1, the previous object may be cleared.

The environment data 350 may include at least one of lighting data for image matching of the augmented object, field of view data related to the augmented object, and GPS data.

The lighting data may include at least one of lighting position data, lighting direction data, lighting type data, lighting color data, and lighting intensity data.

The field of view data may include angle data or position data related to view toward the augmented object.

The GPS setting data may include address data, data representing a longitude coordinate, and data representing a latitude coordinate.

The user interaction data 360 may include interaction type data representing a type of a user interaction and interaction event data representing an event according to the type of the user interaction. The interaction data 360 may be used for the user and the ABM transmission apparatus to exchange various data related to the broadcasting content or the augmented content. Through the user interaction data 360, the ABM transmission apparatus may provide an active augmented broadcasting service to the user.

The instruction time data 370 may include at least one of overlap time data representing a time to display the augmented content on the broadcasting content, life cycle time data of a unit augmented region, a number data representing a number of the instruction unit data 310 that may appear during a life cycle time of the unit augmented region, scale data of the overlap time data, and scale data of the life cycle time data.

The instruction setting data 380 may include at least one of flag data representing first instruction unit data 310 of a new augmented region, identification data identifying a unit augmented region, and instruction priority data representing priority of the instruction unit data 310 appearing during same time.

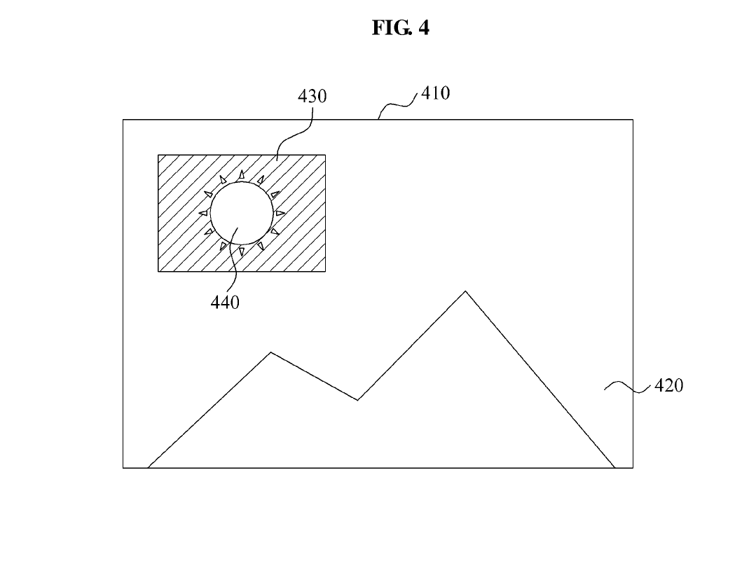

FIG. 4 is a diagram illustrating an example that augmented content 440 is displayed according to instruction unit data analyzed by a user terminal, according to an embodiment of the present invention.

Referring to FIG. 4, a display screen 410 of the user terminal may show broadcasting content 420, an augmented region 430, and the augmented content 440.

The user terminal may analyze ABM and thereby extract augmented region data, reference region data, augmented object data, environment data, and the like from the instruction unit data having same synchronization time as the broadcasting content 420.

The user terminal may display the broadcasting content 420 on the display screen 410 based on the extracted data, designate the augmented region through the reference region data, and display the augmented content 440 on the augmented region 430 according to the augmented object data. Here, the user terminal may implement a natural overlap effect of the broadcasting content 420 and the augmented content 440 based on the environment data. For example, the user terminal may make the augmented content 440 naturally match with the broadcasting content 420 by controlling brightness of the augmented content 440 according to the lighting data included in the environment data, controlling as if blue light or red light were projected, or controlling a shadow position by changing a lighting direction.

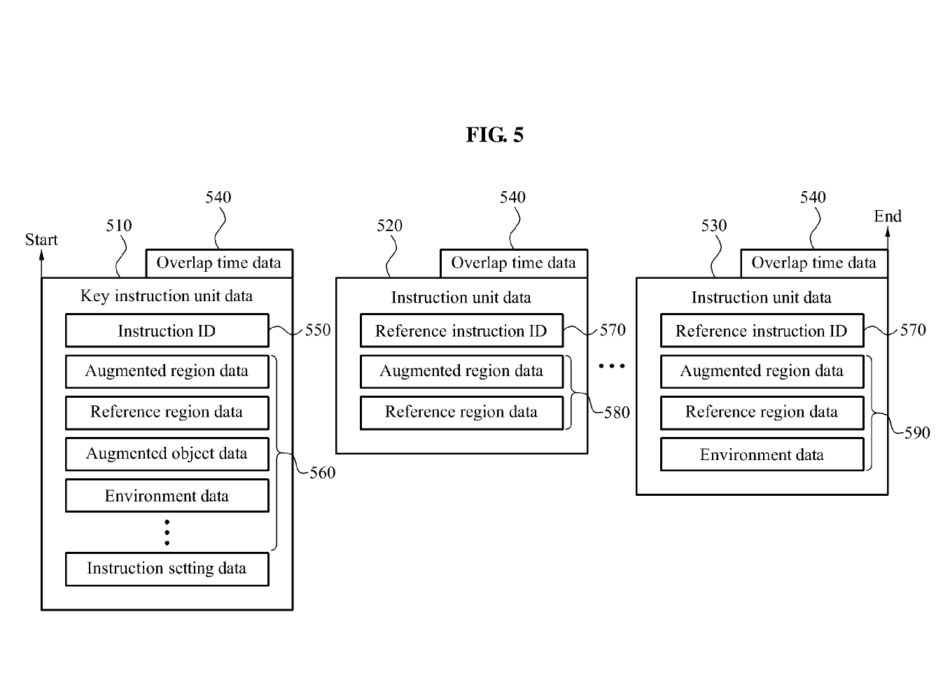

FIG. 5 is a diagram illustrating an example that an ABM transmission apparatus transmits ABM to a user terminal, according to an embodiment of the present invention.

Since the augmented broadcasting is basically in the form of a transmission service, a configuration of the ABM needs to be defined to be proper for metadata transmission. Time information to express augmented content is an essential matter in properly synchronizing and expressing the broadcasting content and the augmented content in a broadcasting terminal. Therefore, a time stamp, which is reference information for fragmentation in transmitting the ABM, is combined with an augmented region or update information of the augmented content and transmitted in units of instruction. An initial instruction may include all information about the augmented region, an augmented object or content, environment data, and the like. However, next instruction of the initial instruction may be transmitted including only changed information.

Referring to FIG. 5, the ABM may be divided into instruction unit data 510, 520, and 530. The instruction unit data 510, 520, and 530 may be defined with reference to the overlap time data 540. The overlap time data 540 may mean time data for displaying the augmented content on the broadcasting content, and may be a reference for synchronization between the broadcasting content and the augmented content. The overlap time data 540 may correspond to the time stamp.

The key instruction unit data 510 may refer to instruction unit data including all data necessary for a newly generated augmented event when the new augmented event is generated. For example, the key instruction unit data 510 may include instruction identifier (ID) data 550, augmented region data, reference region data, augmented object data, environment data, instruction setting data, and the like 560.

After the key instruction unit data 510 is transmitted, the ABM transmission apparatus may generate next instruction unit data 520 and 530 with only changed data 580 and 590 by comparing content 560 of the key instruction unit data 510, and transmit the next instruction unit data 520 and 530 to the user terminal. Thus, the ABM transmission apparatus may reduce quantity of data to be transmitted to the user terminal.

The next instruction unit data 520 and 530 transmitted next the key instruction unit data 510 may designate the key instruction unit data 510 through a reference instruction ID 570. For example, when an instruction ID 550 of the key instruction unit data 510 is ‘INST1’ and the reference instruction ID 570 of the instruction unit data 520 and 530 transmitted next is also ‘INST1’, the user terminal may display the augmented content by reflecting the changed data 580 and 590 of the instruction unit data 520 and 530 while maintaining data of the key instruction unit data 510.

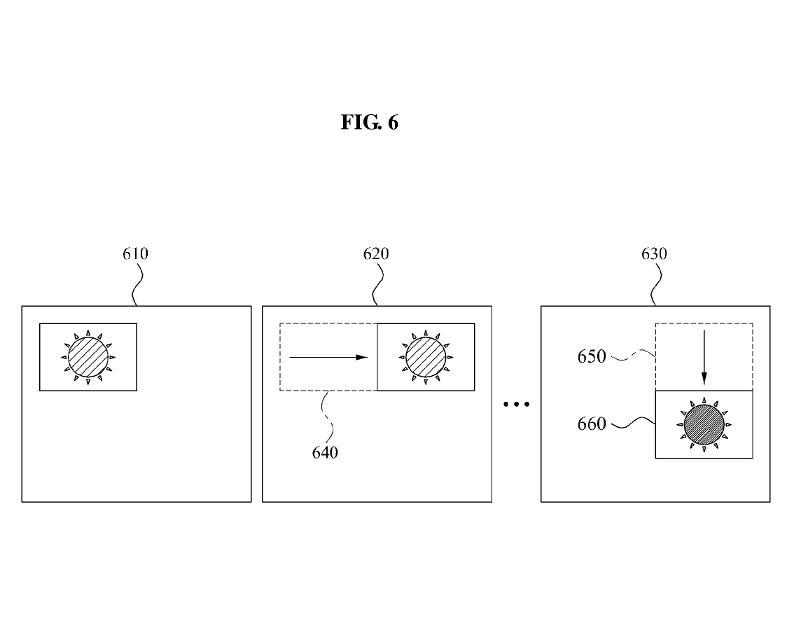

FIG. 6 is a diagram illustrating an example that augmented content is displayed according to a series of ABM received by a user terminal, according to an embodiment of the present invention.

Referring to FIG. 6, the user terminal receiving the key instruction unit data may display augmented content on a screen as shown by 610. When the user terminal receives instruction unit data having a reference instruction ID same as an instruction ID of the key instruction unit data, the user terminal may display next user terminal unit data as shown by 620 and 630 while maintaining content of the key instruction unit data.

For example, when only changed augmented region data and reference region data are included in the instruction unit data as shown by 620, the user terminal may process only the changed augmented region data and reference region data while maintaining the content of the augmented content or lighting setting of the screen. Accordingly, the augmented region may be moved 640.

When instruction unit data next received includes augmented region data, reference region data, and the environment data as shown by 630, the user terminal may move the augmented region as shown by 650 by processing the changed augmented region data and reference region data, and may reduce brightness of the augmented content as shown by 660 or change a position of view with respect to the augmented object according to the changed environment data.

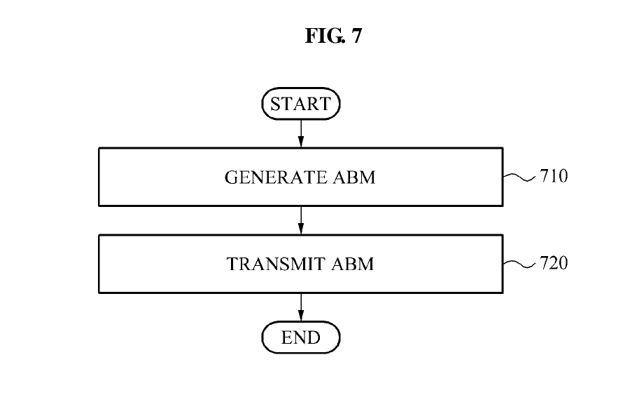

FIG. 7 is a flowchart illustrating an operation of an ABM transmission apparatus transmitting ABM to a user terminal, according to an embodiment of the present invention.

In operation 710, the ABM transmission apparatus may generate ABM related to augmented content to be overlapped on broadcasting content. In addition, the ABM transmission apparatus may generate the ABM into instruction unit data by dividing the ABM by time units. As to this, the ABM transmission apparatus may generate next instruction unit data with only changed data of key instruction unit data that includes all data necessary for a new augmented region.

In operation 720, the ABM transmission apparatus may transmit the ABM to the user terminal. When transmitting the broadcasting content and the ABM together, the ABM transmission apparatus may multiplex the broadcasting content and the ABM and transmit the multiplexed broadcasting content and ABM with one broadcasting stream. Additionally, the ABM transmission apparatus may also transmit the augmented content to the user terminal.

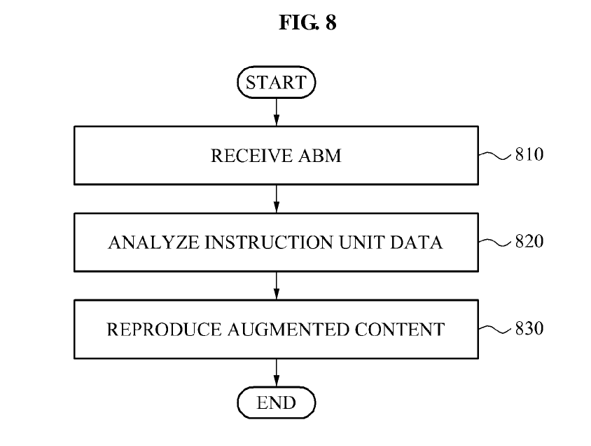

FIG. 8 is a flowchart illustrating an operation of a user terminal reproducing augmented content, according to an embodiment of the present invention.

In operation 810, the user terminal may receive ABM from an ABM transmission apparatus. Depending on cases, the user terminal may receive broadcasting content from a broadcasting content providing server or receive augmented content from an augmented content providing server.

In operation 820, the user terminal may analyze instruction unit data in the received ABM. The user terminal may analyze data included in instruction unit data by dividing the instruction unit data based on a time unit. When the ABM is transmitted along with the broadcasting content with one broadcasting stream, the user terminal may separate the broadcasting content and the ABM from the broadcasting stream, and analyze the ABM with respect to a region and time for expressing the augmented content through parsing.

In operation 830, the user terminal may synchronize the augmented content with the broadcasting content based on the analyzed instruction unit data and reproduce the synchronized content. The user terminal may reproduce the broadcasting content through a conventional decoder, and display the augmented content overlappingly on the broadcasting content according to setting data of the augmented content included in the ABM, based on the region and time for expressing the augmented content.

Hereinafter, syntax for programming the configuration of the ABM and the instruction unit data will be illustrated and corresponding parameters will be defined. In addition, data corresponding to the parameters will be described.

A prefix and a namespace used in the ABM may be as shown in Table 1.

TABLE 1
<prefixes and namespace>

| | |
|---|---|
| refix | Corresponding namespace |
| BM | urn:abss:ver1:represent:augmentingbroadcastingmetadata:2011:07 |

A target namespace and a namespace prefix may be defined as in Table 2 for validation checking of the ABM. Additionally, an import namespace may be defined, which is for use of a type defined in a conventional schema among types used for a present schema.

<?xml version=“1.0”?>
<?xml version=“1.0” encoding=“UTF-8”?>
<schema

xmlns:abm=“urn:etri:ver1:represent:augmentedbroadcastedmetadata:2012:09”
xmlns:mpeg7=“urn:mpeg:mpeg7:schema:2004”
xmlns=“http://www.w3.org/2001/XMLSchema”
targetNamespace=“urn:etri:ver1:represent:augmentedbroadcastedmetadata:2012:09”
elementFormDefault=“qualified”attributeFormDefault=“unqualified”>

<import namespace=“urn:mpeg:mpeg7:schema:2004”

schemaLocation=“mpeg7-v2.xsd”/>

</schema>

1. Root Element

Most significant element of ABM

1.1 Syntax

<!-- Root element -->
<element name=“ABM” type=“abm:ABMType”/>
<complexType name=“ABMType”>
<sequence>
<element name=“DescriptionMetadata”

type=“mpeg7:DescriptionMetadataType” minOccurs=“0”/>

<element name=“InitialInstruction”
type=“abm:InitialInstructionType”

minOccurs=“0” maxOccurs=“unbounded”/>

<element name=“Instruction” type=“abm:InstructionType”
minOccurs=“0”

maxOccurs=“unbounded”/>

</sequence>
</complexType>

1.2 Meaning and Definition

TABLE 2

| Name | Definition |
|---|---|
| ABM | Root element of ABM |
| DescriptionMetadata | Uses mpeg7:DescriptionMetadataType and includes |
| | general information (production data, producer, |
| | authoring information, and the like) of ABM |
| InitialInstruction | Includes information to be periodically transmitted |
| | to terminal according to characteristics of aug- |
| | mented broadcasting |
| Instruction | Standard unit for update of content of ABM, which |
| | may be used as unit of metadata transmission |

Instruction: Instruction unit data

2. Initial Instruction

2.1 Syntax

| <!-- ################################################ --> | |
|---|---|
| <!-- Initial Instruction type | --> |

<!-- ################################################ -->
<element name=“InitInstruction”
type=“abm:InitialInstructionType”/>
<complexType name=“InitialInstructionType”>
<sequence>
<element name=“AugmentedObject”
type=“abm:AugmentedObjectType”

maxOccurs=“unbounded”/>

</sequence>
<attribute name=“id” type=“ID” use=“optional”/>
<attribute name=“contentsNum” type=“unsignedInt”
use=“optional”/>
</complexType>

2.2 Meaning and Definition

TABLE 3

| Name | Definition |
|---|---|
| InitInstruction | Includes augmented information to be transmitted |
| | before transmission of broadcasting content or peri- |
| | odically for augmented broadcasting |
| AugmentedObject | Augmented objects to be overlaid on broadcasting |
| | content are downloaded or uploaded in advance with |
| | respect to a remote server so that display is performed |
| | at a predetermined time without delay. |
| id | ID of initial instruction |
| contentsNum | Number of augmented contents to be included in |
| | initial instruction |

3. Instruction

3.1 Syntax

<!-- ################################################ -->
<!-- Instruction Base type -->
<!-- ################################################ -->
<complexType name=“InstructionBaseType” abstract=“true”>
<complexContent>
<restriction base=“anyType”>
<attribute name=“id” type=“ID” use=“optional”/>
</restriction>
</complexContent>
</complexType>
<!-- ################################################ -->
<!-- Instruction type -->
<!-- ################################################ -->
<complexType name=“InstructionType”>
<complexContent>
<extensionbase=“ABM:InstructionBaseType”>
<sequence>
<element name=“ReferenceResources”
type=“abm:ReferenceResourcesType”

minOccurs=“0”/>

<element name=“AugmentationRegion”
type=“abm:AugmentationRegionType”

minOccurs=“0”/>

<element name=“AugmentedObject”
type=“abm:AugmentedObjectType”

minOccurs=“0”/>

<element name=“EnvironmentInfo”
type=“abm:EnvironmentInfoType”

minOccurs=“0” maxOccurs=“unbounded”/>

<element name=“UserInteraction”
type=“abm:UserInteractionType”

minOccurs=“0” maxOccurs=“unbounded”/>

</sequence>
<attribute name=“firstInstFlag” type=“boolean” use=“optional”/>
<attribute name=“augRegionNum” type=“unsignedInt”
use=“optional”/>
<attribute name=“pts” type=“unsignedInt” use=“required”/>
<attribute name=“duration” type=“unsignedInt” use=“optional”/>
<attribute name=“timeScale” type=“unsignedInt” use=“optional”/>
<attribute name=“numInstruction” type=“unsignedInt”
use=“optional”/>
<attribute name=“priority” type=“unsignedInt” use=“optional”/>
</extension>
</complexContent>
</complexType>

3.2 Meaning and Definition

TABLE 4

| Name | Definition |
|---|---|
| ReferenceResource | Includes reference signal for tracking augmented |
| | region in terminal (Ex: image clip, sound clip, |
| | feature points, etc.) |
| AugmentationRegion | Includes region information of region for over- |
| | lapping and displaying augmented content |
| AugmentedObject | Includes attributes information of augmented |
| | content |
| EnvironmentInfo | Includes environment information necessary for |
| | natural matching of augmented content (Ex: posi- |
| | tion and color of lighting) |
| UserInteraction | Includes augmented content and user interaction |
| | information |
| firstInstFlag | Denotes whether it is first instruction with respect |
| | to new augmented region. When firstInstFlag is 1, |
| | it is first instruction |
| augRegionNum | Number for identifying augmented region, which |
| | has same augRegionNum value in next instruction |
| | with respect to same augmented region |
| pts | Denotes time to express instruction |
| duration | Denotes life cycle time of augmented region |
| timeScale | Denotes scale value with respect to expression |
| | time of pts and duration (Ex: Timescale = “1000” |
| | means a time value of 1000 tics per second.) |
| numInstruction | Denotes number of instructions that may be |
| | shown during life cycle of augmented region |
| priority | Denotes priority of instructions shown at same |
| | time |

ReferenceRegion: Reference region data
AugmentingRegion: Augmented region data
AugmentingObject: Augmented object data
EnvironmentInfo: Environment data
UserInteraction: User interaction data
GlobalPosition: GPS data of augmented region
firstInstFlag: Flag data
augRegionNum: Identification data
pts: Overlap time data
duration: Life cycle time data
timeScale: Overlap time data and scale data of life cycle time data
numInstruction: Number data of instruction unit data
priority: Instruction priority data

4. Reference Region

4.1 Syntax

<!-- ########################################## -->
<!-- Definition of Reference Region Type -->
<!-- ########################################## -->
<complexType name=“ReferenceResourcesType”>
<sequence>
<element name=“Resources” type=“string” minOccurs=“0”

maxOccurs=“unbounded”/>

</sequence>
</complexType>

4.2 Meaning and Definition

TABLE 5

| Name | Definition |
|---|---|
| Resources | Includes position information for retrieving augmented |
| | content necessary for broadcasting content |

5. Augmenting Region

5.1 Syntax

<!-- ########################################## -->
<!-- Definition of Augmentation Region Type -->
<!-- ########################################## -->
<complexType name=“AugmentationRegionType”>
<sequence>
<element name=“TransformMatrix” type=“ABM:FloatMatrixType”

minOccurs=“0”/>

<element name=“Coordinates” type=“ABM:CoordinateType”
minOccurs=“0”/>
<element name=“SRT” type=“ABM:SRTType” minOccurs=“0”/>
</sequence>
</complexType>
<complexType name=“CoordinateType”>
<attribute name=“x1” type=“ABM:zeroToOneType”
use=“optional”/>
<attribute name=“y1” type=“ABM:zeroToOneType”
use=“optional”/>
<attribute name=“z1” type=“ABM:minusOneToOneType”
use=“optional”/>
<attribute name=“x2” type=“ABM:zeroToOneType”
use=“optional”/>
<attribute name=“y2” type=“ABM:zeroToOneType”
use=“optional”/>
<attribute name=“z2” type=“ABM:minusOneToOneType”
use=“optional”/>
<attribute name=“x3” type=“ABM:zeroToOneType”
use=“optional”/>
<attribute name=“y3” type=“ABM:zeroToOneType”
use=“optional”/>
<attribute name=“z3” type=“ABM:minusOneToOneType”
use=“optional”/>
attribute name=“x4” type=“ABM:zeroToOneType”
use=“optional”/>
<attribute name=“y4” type=“ABM:zeroToOneType”
use=“optional”/>
<attribute name=“z4” type=“ABM:minusOneToOneType”
use=“optional”/>
</complexType>
<complexType name=“SRTType”>
<attribute name=“sx” type=“float” use=“optional”/>
<attribute name=“sy” type=“float” use=“optional”/>
<attribute name=“sz” type=“float” use=“ optional ”/>
<attribute name=“rx” type=“float” use=“ optional ”/>
<attribute name=“ry” type=“float” use=“ optional ”/>
<attribute name=“rz” type=“float” use=“optional”/>
<attribute name=“tx” type=“float” use=“optional”/>
<attribute name=“ty” type=“float” use=“optional”/>
<attribute name=“tz” type=“float” use=“optional”/>
</complexType>
<!-- FloatMatrixType -->
<complexType name=“FloatMatrixType”>
<simpleContent>
<extension base=“ABM:FloatVector”>
<attribute ref=“mpeg7:dim” use=“required”/>
</extension>
</simpleContent>
</complexType>
<simpleType name=“FloatVector”>
<list itemType=“float”/>
</simpleType>
<simpleType name=“zeroToOneType”>
restriction base=“float”>
<minInclusive value=“0.0”/>
<maxInclusive value=“+1.0”/>
</restriction>
</simpleType>
<simpleType name=“minus OneToOneType”>
restriction base=“float”>
<minInclusive value=“−1.0”/>
<maxInclusive value=“+1.0”/>
</restriction>
</simpleType>

5.2 Meaning and Definition

TABLE 6

| Name | Definition |
|---|---|
| TransformMaxtrix | 3 × 3 matrix value for obtaining 3D coordinate dis- |
| | placement value |
| Coordinate | 3D coordinate value |
| SRT | Rotation, scale, translation values with respect to x, |
| | y, and z |
| X1, y1, z1 | Left-upper x, y, z coordinate |
| X2, y2, z2 | Right-upper x, y, z coordinate |
| X3, y3, z3 | Right-lower x, y, z coordinate |
| X4, y4, z4 | Left-lower x, y, z coordinate |
| sx, sy, sz | Scale value with respect to x, y, and z axes |
| rx, ry, rz | Rotation value with respect to x, y, and z axes |
| tx, ty, tz | Translation value with respect to x, y, and z axes |

* One of transformMatrix, coordinate, SRT methods may be used.

6. Augmenting Object

6.1 Syntax

<!-- ########################################## -->
<!-- Definition of Augmented Object Type -->
<!-- ########################################## -->
<complexType name=“AugmentedObjectType”>
<choice>
<element name=“Inline” type=“mpeg7:InlineMediaType”
minOccurs=“0”/>
<element name=“Remote” type=“anyURI” minOccurs=“0”/>
<element name=“Tactile” type=“abm:TactileType” minOccurs=“0”/>
</choice>
<attribute name=“clearFlag” type=“boolean” use=“optional”/>
<attribute name=“service” use=“optional”>
<simpleType>
<restriction base=“string”>
<enumeration value=“entertain”/>
<enumeration value=“education”/>
<enumeration value=“character”/>
</restriction>
</simpleType>
</attribute>
<attribute name=“emotion” use=“optional”>
<simpleType>
<restriction base=“string”>
<enumeration value=“happy”/>
<enumeration value=“sad”/>
<enumeration value=“angry”/>
enumeration value=“sick”/>
</restriction>
</simpleType>
</attribute>
</complexType>
<!-- ########################################## -->
<!-- Definition of Tactile Type -->
<!-- ########################################## -->
<complexType name=“TactileType”>
<sequence>
<element name=“ArrayIntensity” type=“mpeg7:FloatMatrixType”/>
</sequence>
<attribute name=“tactileEffect” type=“abm:tactileEffectType”
use=“required”/>
<attribute name=“timeSamples” type=“positiveInteger” use=“optional”/>
</complexType>
<simpleType name=“tactileEffectType”>
restriction base=“string”>
<enumeration value=“pressure”/>

<enumeration value=“vibration”/>
<enumeration value=“electric”/>

</restriction>
</simpleType>

6.2 Meaning and Definition

TABLE 7

| Name | Definition |
|---|---|
| Inline | Includes binary data when augmented content is embedded |
| | in metadata |
| remote | Includes URI denoting that augmented content is present |
| | outside (ex: remote server or local disc) |
| Tactile | Used when tactile information is included in metadata not |
| | URI form |
| clearFlag | Indicates whether to clear previous augmented object before |
| | overlapping augmented object. When clearFlag is 1, pre- |
| | vious augmented object is cleared. |
| service | Defines service type of augmented object. Ex: entertain- |
| | ment, education, and avatar |
| emotion | Defines emotion of augmented object. Ex: happy, sad, |
| | angry, and sick |
| ArrayIntesity | Indicates intensity of actuator. Arrayintensity is expressed |
| | in array form.. |
| tactileEffect | Indicates actuator type to be used for tactile effect. |
| | (Ex: pressure, vibration) |
| timeSamples | Indicates number of samples updated per second. |

Inline: Augmented content data
remote: URL data
service: Service type data of augmented object
emotion: Emotion data of augmented object
clearFlag: Clear data

7. Environment Info

7.1 Syntax

<!--########################################## -->
<!-- Definition of Environment Info Type -->
<!--########################################## -->
<complexType name=″EnvironmentInfoType″>
<sequence>
<element name=″GlobalPosition″ type=″ABM:GlobalPositionType″

minOccurs=″0″ maxOccurs=″unbounded″/>

<element name=″Light″ type=″ABM:LightType″ minOccurs=″0″

maxOccurs=”unbound”/>

<element name=″Camera″ type=″ABM:CameraType″
minOccurs=″0″

maxOccurs=″unbounded″/>

</sequence>
</complexType>
<!--#################################### -->
<!--Definition of Global Position type -->
<!--#################################### -->
<complexType name=″GlobalPositionType″>
<sequence>
<element name=″Address″ type=″mpeg7:PlaceType″
minOccurs=″0″/>
</sequence>
<attribute name=″longitude″ use=″required″>
<simpleType>
<restriction base=″double″>
<minInclusive value=″−180.0″/>
<maxInclusive value=″180.0″/>
</restriction>
</simpleType>
</attribute>
<attribute name=″latitude″ use=″required″>
<simpleType>
<restriction base=″double″>
<minInclusive value=″−90.0″/>
<maxInclusive value=″90.0″/>
</restriction>
</simpleType>
</attribute>
</complexType>
<!--#################################### -->
<!--Definition of Light type -->
<!--#################################### -->
<complexType name=″LightType″>
<sequence>
<element name=″Position″ type=″ABM:DirectionType″
minOccurs=″0″/>
<element name=″Rotation″ type=″ABM:RotationType″
minOccurs=″0″/>
</sequence>
<attribute name=″type″ type=″unsignedInt″ use=″optional″/>
<attribute name=″color″ type=″ABM:ColorType″ use=″optional″/>
<attribute name=″intensity″ type=″ABM:zeroToOneType″/>
</complexType>
<complexType name=″PositionType″>
<attribute name=″px″ type=″float″ use=″optional″/>
<attribute name=″py″ type=″float″ use=″optional″/>
<attribute name=″pz″ type=″float″ use=″optional″/>
</complexType>
<complexType name=″RotationType″>
<attribute name=″vx″ type=″float″ use=″optional″/>
<attribute name=″vy″ type=″float″ use=″optional″/>
<attribute name=″vz″ type=″float″ use=″optional″/>
</complexType>
<!--#################################### -->
<!--Definition of Color type -->
<!--#################################### -->
<simpleType name=″ColorType″>
<restriction base=″NMTOKEN″>
<whiteSpace value=″collapse″/>
<pattern value=″#[0-9A-Fa-f]{6}″/>
</restriction>
</simpleType>
<!--#################################### -->
<!--Definition of Camera type -->
<!--#################################### -->
<complexType name=″CameraType″>
<attribute name=″fov″ type=″float″ use=″optional″/>
</complexType>

7.2 Meaning and Definition

TABLE 8

| Name | Definition |
|---|---|
| GlobalPosition | Indicates GPS information |
| Address | Indicates address |
| longitude | Indicates longitude coordinate |
| latitude | Indicates latitude coordinate |
| Light | Includes lighting information for augmented object |
| Position | Indicates position of lighting and has 3D coordinate |
| | value. |
| Rotation | Indicates direction of lighting and has 3D coordinate |
| | value. |
| type | Indicates type of lighting. Type of lighting changes |
| | according to values below. |
| | 1: point light |
| | 2: directional light |
| | 3: spot light |
| Color | Indicates color of lighting. Color is expressed by com- |
| | bination of RGB values. |
| | Ex) #FF0000 |
| intensity | Has lighting intensity value. |
| Camera | Indicates camera information. |
| Fov | Has field of view value. |

Camera, fov: Fov data
GlobalPosition, Address, longitude, latitude: GPS setting data
Position: Lighting position data
Rotation: Lighting direction data
Type: Lighting type data
Color: Lighting color data
Intensity: Lighting intensity data

8. User Interaction

8.1 Syntax

<!-- ########################################## -->
<!-- Definition of User Interaction Type - >
<!-- ########################################## -->
<complexType name=“UserInteractionType”>
<choice>
<element name=“ReplaceResource” type=“anyURI” minOccurs=“0”/>

<element name=“ChangeRotation” type=“boolena” minOccurs=“0”/>
<element name=“ChangeScale” type=“boolean” minOccurs=“0”/>

</choice>
<attribute name=“event” type=“abm:eventType” use=“optional”/>
</complexType>
<simpleType name=“eventType”>
<restriction base=“string”>
<enumeration value=“touch”/>
<enumeration value=“drag”/>
<enumeration value=“zoom”/>
</restriction>
</simpleType>

8.2 Meaning and Definition

TABLE 9

| Name | Definition |
|---|---|
| ReplaceResource | Includes URI information for replacing resources of |
| | augmented object |
| ChangeRotation | Has value 1 when rotation change of augmented |
| | object is allowed. |
| ChangeScale | Has value 1 when scale change of augmented content |
| | is allowed. |
| event | Indicates type of event. Touch, drag, and zoom may |
| | be selected as event type. |

Interaction: Interaction type data
Event: Interaction event data

Embodiments using augmented broadcasting metadata are shown below.

<First embodiment - Syntax >
<ABM>
<Instruction id=″ID_1″ firstInstFlag=”true” augRegionNum=″1″
pts=″100″

duration=″200″ timescale=”100” numInstruction=″1″ priority=”1”>

<AugmentationRegion>

<Coordinates x1=″179″ y1=″104″ z1=″−68″ x2=″123″
y2=″104″ z2=″−68″

x3=″123″ y3=″47″ z3=″−78″ x4=″179″ y4=″47″ z4=″−78″ />

</AugmentationRegion>
<AugmentedObject>
<Remote>hppt://augmenting.server.com/avatar.jpg</Remote>
</AugmentedObject>
<EnvironmentInfo>

<Light type=”1” color″#008000″ intensity=″10″>

<Position px=″0″ py=″0″ pz=″0″ />
<Rotation vx=″0″ vy=″0″ vz=″0″ />

</EnvironmentInfo>
</Instruction>
</ABM>

The above syntax illustrates an embodiment in that a rectangular augmented region is designated and an avatar image in a remote server is overlapped based on a 3D coordinate with respect to 4 coordinates of the augmented region. The syntax includes environment information of white lighting at a left for the lighting effect.

<Second embodiment - Syntax >
<ABM>
Instruction id=″ID_1″ firstInsFlag=”true” augRegionNum=”3”
pts=”200”

duration=″200″ timescale=”100” numInstruction=″2″ priority=″1″>

<AugmentationRegion>

<Coordinates x1=″179″ y1=″104″ z1=″−68″ x2=″123″
y2=″104″ z2=″−68″

x3=″123″ y3=″47″ z3=″−78″ x4=″179″ y4=″47″ z4=″−78″ />

</AugmentationRegion>
<AugmentedObject>
<Remote>hppt://augmenting.server.com/avatar.jpg</Remote>

</AugmentedObject>

</Instruction>
<Instruction id=″ID_2″ firstInsFlag=”false”
augRegionNum=”3” pts=″250″>
<AugmentationRegion>

<SRT sx=″1″ sy=″1″ sz=″1″ rx=″20″ ry=″10″
rz=″20″ tx=″0″ ty=″0″

tz=″0″ />

</AugmentationRegion>
</Instruction>
</ABM>

The above syntax illustrates an embodiment in that the rectangular augmented region appears overlapping with the augmented object in the beginning and then moves after 250 tics. A translation matrix is used for translation of the augmented region.

The above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An augmented broadcasting metadata (ABM) transmission apparatus comprising:
a metadata generation unit to generate ABM related to an augmented content to be overlapped with broadcasting content; and
a metadata transmission unit to transmit the ABM to a user terminal.

2. The ABM transmission apparatus of claim 1, wherein the metadata generation unit generates instruction unit data by dividing the ABM by time units.

3. The ABM transmission apparatus of claim 2, wherein the instruction unit data comprises at least one selected from augmented region data related to an augmented region in which the augmented content is to be displayed in an overlapping manner, reference region data related to a position of the augmented region, augmented object data related to attributes of the augmented content, environment data necessary for overlap between the broadcasting content and the augmented content, user interaction data related to the augmented content, and instruction time data necessary for synchronization between the broadcasting content and the augmented content, and instruction setting data for setting of the instruction unit data.

4. The ABM transmission apparatus of claim 3, wherein the augmented region data comprises at least one of augmented region shape data indicating a shape of the augmented region, mask image data for expressing the augmented region, and global positioning system (GPS) data of the augmented region.

5. The ABM transmission apparatus of claim 3, wherein the reference region data comprises at least one of coordinate data of the augmented region, displacement data of the augmented region, and boundary data indicating a boundary of a mask image included in the augmented region.

6. The ABM transmission apparatus of claim 3, wherein the augmented object data comprises at least one of augmented content data embedded in the ABM, uniform resource locator (URL) data corresponding to a location of the augmented content, service type data of the augmented object, emotion data of the augmented object, and clear data related to deletion of an augmented object.

7. The ABM transmission apparatus of claim 3, wherein the environment data comprises at least one of lighting data for image matching of the augmented object, field of view data related to the augmented object, and GPS setting data,
wherein the lighting data comprises at least one of lighting position data, lighting direction data, lighting type data, lighting color data, and lighting intensity data.

8. The ABM transmission apparatus of claim 3, wherein the interaction data comprises interaction type data representing a type of a user interaction and interaction event data representing an event according to the type of the user interaction.

9. The ABM transmission apparatus of claim 3, wherein the instruction time data comprises at least one of overlap time data representing a time to display the augmented content on the broadcasting content, life cycle time data of a unit augmented region, a number data representing a number of the instruction unit data that may appear during a life cycle time of the unit augmented region, scale data of the overlap time data, and scale data of the life cycle time data.

10. The ABM transmission apparatus of claim 3, wherein the instruction setting data comprises at least one of flag data representing first instruction unit data of a new augmented region, identification data identifying a unit augmented region, and instruction priority data representing priority of the instruction unit data appearing during same time.

11. The ABM transmission apparatus of claim 2, wherein the metadata generation unit generates next instruction unit data from changed data of previous instruction unit data.

12. The ABM transmission apparatus of claim 2, wherein the metadata generation unit generates next instruction unit data from changed data of key instruction unit data that includes all necessary data related to a new augmented region.

13. The ABM transmission apparatus of claim 1, wherein the metadata transmission unit multiplexes the broadcasting content and the ABM and transmits the broadcasting content and the ABM by one broadcasting stream.

14. A user terminal comprising:
a metadata receiving unit to receive augmented broadcasting metadata (ABM) from an ABM transmission apparatus;
a metadata analysis unit to analyze instruction unit data in the ABM; and
an augmented content reproduction unit to synchronize the broadcasting content with the augmented content based on the analyzed instruction unit data and reproduce the broadcasting content and the augmented content.

15. The user terminal of claim 14, wherein the instruction unit data is data formed by dividing the ABM based on time units.

16. The user terminal of claim 14, wherein the instruction unit data comprises at least one selected from augmented region data related to an augmented region in which the augmented content is to be displayed in an overlapping manner, reference region data related to a position of the augmented region, augmented object data related to attributes of the augmented content, environment data necessary for overlap between the broadcasting content and the augmented content, user interaction data related to the augmented content, and instruction time data necessary for synchronization between the broadcasting content and the augmented content, and instruction setting data for setting of the instruction unit data.

17. The user terminal of claim 14, wherein the metadata analysis unit analyzes a display method for the augmented region and the augmented content by analyzing the instruction unit data based on time units.

18. The user terminal of claim 14, wherein the metadata analysis unit analyzes the ABM by separating the ABM and the broadcasting content from a broadcasting stream when the ABM and the broadcasting content are transmitted by one broadcasting stream.

19. An augmented broadcasting metadata (ABM) transmission method comprising:
generating ABM related to augmented content to be overlapped with broadcasting content; and
transmitting the ABM to a user terminal.

20. An augmented broadcasting metadata (ABM) reproduction method comprising:
receiving ABM from an ABM transmission apparatus;
analyzing instruction unit data in the ABM; and
synchronizing the broadcasting content with the augmented content based on the analyzed instruction unit data and reproducing the broadcasting content and the augmented content.
